(19) United States
(12) Patent Application Publication
(10) Pub. No.: US 2016/0129819 A1
(43) Pub. Date: May 12, 2016

(54) REMOVABLE ANTIMICROBIAL SEAT COVER

(71) Applicant: SAVE OUR SEATS, LLC, KAMAS, UT (US)

(72) Inventors: Max L. Johnson, JR., Atlanta, GA (US); Carrie J. Fullen, Kamas, UT (US)

(73) Assignee: SAVE OUR SEATS, LLC, KAMAS, UT (US)

(21) Appl. No.: 14/938,640

(22) Filed: Nov. 11, 2015

Related U.S. Application Data
(60) Provisional application No. 62/078,776, filed on Nov. 12, 2014.

(51) Int. Cl. B60N 2/60; B60N 2/58

(52) U.S. Cl. CPC B60N 2/60; B60N 2/5891

(57) ABSTRACT

A removable antimicrobial seat cover is described. The cover includes a continuous antimicrobial seat cover. The cover has a first surface to cover a seat portion of the seat and a second surface to cover a seat back portion of the seat. The cover also includes a storage mechanism to store the continuous antimicrobial seat cover away from the seat when not in use. The storage mechanism is coupled to the seat when the continuous antimicrobial seat cover is not in use. The device also includes a retention mechanism to removably couple the storage mechanism to the seat.

### RELATED

The present application claims priority under 35 U.S.C. §119 [symbol] to U.S. Provisional Application No. 62/078,776 entitled “Removable Antimicrobial Seat Cover.” Which application is hereby incorporated by reference in its entirety.

### BACKGROUND

Vehicles are an increasingly significant component of many individual's lives. For example, many individuals rely on vehicles for transportation to and from work, entertainment destinations, and recreational sites among other destinations. During use, such vehicles are exposed to dirt, dust, and other particulate matter that may reduce the vehicle's effective life and usefulness to an owner and may have other undesirable results.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIGS. 1A and 1B are perspective views of a removable antimicrobial seat cover, the removable seat cover in a storage mode according to one example of the principles described herein.

FIGS. 2A and 2B are perspective views of a removable antimicrobial seat cover, the removable seat cover in a deployed mode according to one example of the principles described herein.

FIG. 3 illustrates the positioning of the removable antimicrobial seat cover in a storage mode according to one example of the principles described herein.

FIG. 4 is a back view of the removable antimicrobial seat cover in a transport mode according to another example of the principles described herein.

FIG. 5 is a side view of the removable antimicrobial seat cover in a deployed mode according to another example of the principles described herein.

FIG. 6 is a perspective view of the removable antimicrobial seat cover for protecting a bench seat according to one example of the principles described herein.

FIG. 7 is a perspective view of the removable antimicrobial seat cover having a belt portion according to one example of the principles described herein.

FIG. 8 is a flow diagram of a method of making a removable antimicrobial seat cover according to one example of the principles described herein.

FIG. 9 is a perspective view of the removable antimicrobial seat cover, the removable seat cover in a deployed mode according to another example of the principles described herein.

Throughout the drawings, identical reference numbers designate similar, but not necessarily identical, elements.

### DETAILED DESCRIPTION

Vehicles are an increasingly significant component of many individual's lives. For example, many individuals rely on vehicles for transportation to and from work, entertainment destinations, and recreational sites among other destinations. During use, such vehicles are exposed to dirt, dust, and other solids and liquids that may reduce the vehicle's effective life and use for an owner.

For example, many individuals have active lifestyles. Activities such as running, weight lifting, aerobics, yoga, spinning, and biking, are becoming increasingly popular. Individuals engaging in these activities use their vehicle to travel to particular destinations. After engaging in the activity, the individual's clothing and the individual may be wet, sweaty, or dirty. In this state the individual may again use their vehicle to return to their home, office, or other destination. Also, some professions, such as an auto mechanic or a landscaper, may result in the individual becoming soiled with various liquids and solids. Sitting in a vehicle in an unclean state can be detrimental to the vehicle.

For example, sweat, dirt and other particulate matter may be harmful to the fabric of the seat. More specifically, sweat, dirt and other particles create accelerated wear on the surface fabrics of the car seat as well as the interior layers. Not only are the sweat, its chemical constituents, and other dirt particles harmful to the car seat, they may also create an unpleasant odor inside the vehicle.

Moreover, in addition to using the vehicle for transportation from an activity that may result in dirty clothing, a user often uses the vehicle for other types of transportation such as to work, or social events where presumably they are in clean clothing. Travelling in the previously soiled car seat may have undesirable effects on the clean clothing of the user as sweat and dirt particles that have accumulated in the car seat are transferred to the clean clothing.

Accordingly, not only do the sweat, dirt, and other particulate matter reduce the life of the vehicle, but the sweat which may get soaked into the surface of the car seat fabric, may also later transition onto the clean clothing of the user. This, in turn, may reduce the time after which fresh clothing needs to be laundered. Accordingly, dirty or soiled car seats lead to an increase in energy use, resource (i.e., water, detergent, and electricity) use, and monetary expense used to maintain a desired cleanliness standard of this clothing. The same effects result from soiled seat belts as the seat belt also comes into cyclic contact with dirty and clean clothing.

Bacteria transmission from the use of a car seat with both fresh and soiled clothing is exacerbated given the increased popularity of active lifestyles. For example, it is not uncommon for individuals to take part in physical activities three to five times per week or more, during which they sweat. Moreover, as described above, professionals with inherently dirty occupations may use a vehicle many times a week, if not every day, while engaging in their profession. While some protective seat covers exist, they are inherently ineffective and inefficient for quick use and deployment. For example, current car seat covers are either of a permanent type or a temporary type. Permanent seat covers are just that, and therefore it is not practical to remove and re-install a permanent seat cover multiple times per week. Moreover, the permanent seat covers suffer from the same complications as the automobile seat in that they see both soiled clothing and clean clothing and may transfer the odor from soiled clothing to clean clothing.

In regards to temporary car seat covers, after use the entire seat cover is removed from the seat itself and then placed elsewhere in the vehicle, such as the passenger's seat, the rear seat, or a trunk. Installation and removal of these temporary seat covers may be difficult as with this type of seat cover the user picks up the entire seat cover and engages in the awkward and time consuming task of lining up the cover with the seat, for example using the headrest as a guide. This is done by reaching up and over the headrest while facing squarely with the seat back. This approach not only takes up time to perform, but it also puts the user in a contorted position that is uncomfortable and awkward when one is entering or exiting the vehicle. Moreover, neither the permanent car seat covers nor the temporary car seat covers offer a protection between soiled clothing and a seat belt of the vehicle.

Accordingly, the present specification describes systems and devices that remedy these and other complications. Specifically, the present specification describes a removable antimicrobial seat cover that is quickly deployed as needed, for example when travelling in soiled clothing. The removable seat cover is also quickly retracted and stored as needed, for example when traveling in clean clothing. In other words, the present specification describes a quickly removable and deployable seat cover that retracts, or pulls the seat cover material away from the user/seat interface, while not in use and quickly and efficiently deploys the seat cover material to the user/seat interface just prior to use.

The seat cover, while deployed, may wick away liquids and keep the seat itself from becoming soiled due to mud, food, grease, sweat, and other solid and liquid elements. The protective seat cover may include a separate or attached component to protect the seat belt of the seat from becoming wet/soiled. The seat cover may be constructed using anti-microbial/anti-bacterial products to reduce odor and promote the elimination of harmful and undesirable microbes/bacteria. In some examples, the seat cover may be consolidated into a bag which may be easily carried, in some examples leaving a user's hands free for carrying other objects. The seat cover and bag are designed to be removed and laundered on a frequent basis, and for many cycles. The protective seat cover may be built for any type and size of seat including individual seats, such as a driver or passenger seat, as well as larger seats such as second row bench seats.

In summary, the present disclosure describes a removable antimicrobial seat cover. The cover includes a continuous antimicrobial seat cover. The cover has a first surface to cover a seat portion of the seat and a second surface to cover a seat back portion of the seat. The cover also includes a storage mechanism to store the continuous antimicrobial seat cover away from the seat when not in use. The storage mechanism is coupled to the seat when the continuous antimicrobial seat cover is in use. When the continuous antimicrobial seat cover is not in use, the storage mechanism is also coupled to the seat. The cover also includes a retention mechanism to removably couple the storage mechanism to the seat.

The present disclosure describes a removable seat protection system. The system includes an antimicrobial seat cover sized to cover a seat. The seat cover has a first surface to cover a seat portion of the seat and a second surface to cover a seat back portion of the seat. The system also includes an antimicrobial belt cover disposed along an edge of the antimicrobial seat cover. The belt cover is sized to provide a barrier between a safety belt and a user. The system also includes an antimicrobial hood sized to cover a headrest portion of the seat. The system includes a storage mechanism to store the seat cover, belt cover, and hood away from the seat when not in use. The storage mechanism is coupled to the seat when the continuous antimicrobial seat cover is not in use. The system also includes a retention mechanism to removably couple the storage mechanism to the seat.

The present disclosure describes a method for making a removable antimicrobial seat cover. The method includes forming a seat cover out of an antimicrobial material. The seat cover being elongated and sized to fit over at least a seat portion of an automobile seat and a seat back portion of an automobile seat. The method further includes forming a storage mechanism, in which the seat cover is disposed inside of the storage mechanism when not in use and forming a retention mechanism to removably couple the seat cover to the seat.

As used in the present specification and in the appended claims, the term “a number of” or similar language is meant to be understood broadly as any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

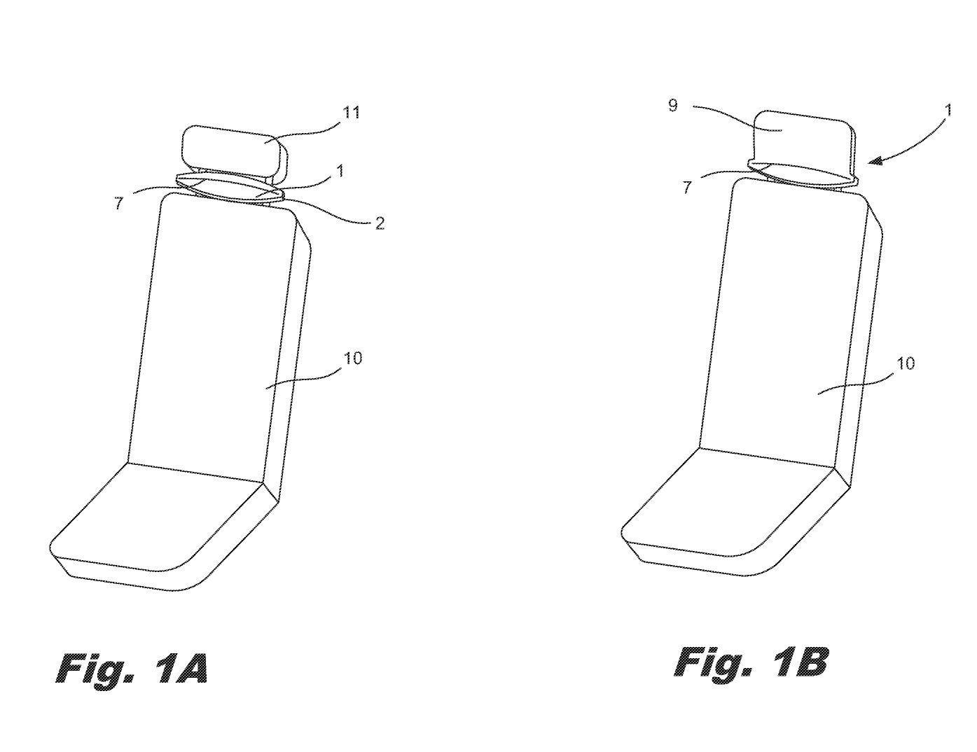

FIGS. 1A and 1B are perspective views of a removable antimicrobial seat cover, the removable seat cover in a storage mode according to one example of the principles described herein. As described above, the present disclosure relates to a seat cover that is secured to a car seat (10), for example, around the top portion of the seat (10), which may or may not include a detachable headrest (11).

In some examples, the cover may include a storage mechanism to store the continuous antimicrobial seat cover away from the seat (10) when not in use. In some examples, the storage mechanism may be a bag (1) or pouch that retains the antimicrobial seat cover. When the seat cover is in a retracted mode, the seat cover material itself is retained by the storage mechanism, for example the seat cover material sits within the pouch or small bag (1). The storage mechanism (such as the bag (1)) may be located on either the front-facing part of the seat (10), or the rear-facing part of the seat (10) on or near the headrest (11).

The storage mechanism, when fully storing the seat cover in a retracted mode, is narrow enough not to cause discomfort or a safety hazard to the user of the seat (10). When the user wishes to deploy the seat cover, a zipper (7), straps, buttons, a fold, or the like will be opened and the seat cover will fall downwards where the user can manually lay the material down to obtain full seat coverage with the seat cover. The seat and seat fabrics are then protected with the seat cover. In the reverse manner, if the user wishes to retract the seat cover, the seat cover is manually moved into the storage mechanism by folding, stuffing, rolling, or the like, the seat cover back into the bag so that the seat cover is held into position with a zipper (7), straps, buttons, folds, or the like.

In this example, the continuous antimicrobial seat cover may be folded, stuffed, rolled, or otherwise disposed inside the storage mechanism. Storing the continuous antimicrobial seat cover inside a storage mechanism such as the bag (1) or pouch may include folding the seat cover such that a surface of the material that has come into contact with the soiled clothing is not in contact with other surfaces which are clean. In this fashion any contamination from sweat, or other solids and liquids may be contained to a single surface of the seat cover without coming into contact with and contaminating other surfaces. In this fashion, the continuous antimicrobial seat cover may enable non-contamination of surfaces of the seat cover that come into contact with the car seat (10). In some examples, the storage mechanism may sit near the top of the car seat. While FIGS. 1A and 1B depict a bag (1) or pouch being disposed near the top of the car seat (10), the bag (1) or other storage mechanism may be disposed on any surface of the car seat (10) such as a side surface, a surface underneath the car seat (10), or a seat surface. The seat cover bag (1) may be manufactured from various materials. For example, the seat cover bag (1) may be made of an antimicrobial product that promotes the elimination of microbes or other bacterial elements. In some examples, the storage bag (1) may have an airtight seal to contain undesirable odors. For example, the bag (1) may include a zipper (7) to ensure that the bag (1) remains closed while holding the seat cover in a retracted mode. The bag (1) may also include additional material, such as a flap to cover the zipper (7) to further contain undesirable odors. To deploy the seat cover, the zipper (7) is simply unzipped, and the seat cover rolls out or unfolds out of the storage mechanism (i.e., bag (1)). The user then manually moves the seat cover into position so that the cover obtains maximum coverage for maximum protection and user comfort. In another example, the storage bag (1) may be constructed so as to allow the odor to dissipate and the seat cover to dry out if needed. For example, the storage bag (1) may be formed of an open mesh. In another example, the storage mechanism may be a strap that allows free flow of air around the seat cover.

While FIGS. 1A and 1B depict a bag (1) or pouch, the storage mechanism may be any device that retains the seat cover away from the user while in use. Examples of such storage mechanisms include straps, buckles, snaps, hook and loop fasteners, and magnets, among other storage mechanisms.

The cover may also include a retention mechanism (2) to removably couple the storage mechanism to the seat (10). For example, the retention mechanism (2) may include straps that removably couple the storage mechanism, and included seat cover, near the headrest (11) of the car seat (10). Other examples of retention mechanisms (2) include buckles, hook and loop fasteners, clips, and chords, among other retention devices.

In some examples, the cover may include a hood that is used to cover the headrest (11). In this example, the storage bag (1) may be integrally formed with a hood portion (9) of the cover as depicted in FIG. 1B. In this example the hood portion (9) may include a tightening mechanism such as a drawstring to tighten the outer diameter of the hood (9) around the base of the headrest (11) such that the seat cover is anchored to the seat (1). In this example, the hood portion (9) may cover the headrest (11) while the rest of the car seat cover, i.e., the first portion and the second portion, are stored via the storage mechanism.

As depicted in FIG. 1A, the storage mechanism, such as the bag (1), may be positioned on a front side of the car seat (10). Including the storage mechanism on the front side of the car seat (10) may be beneficial in that it allows for easy deployment of the car seat cover without having to move the storage mechanism between a front side and a rear side of the car seat for every use.

In some examples, the storage mechanism (bag (1)) may be coupled to the car seat (10) while the car seat cover is in a retracted mode. In other words, the retention mechanism (2) of the storage mechanism may allow for the car seat cover to be attached to the car seat (10) even while the car seat cover is stored via the storage mechanism.

As depicted in FIG. 1A, the bag (1) may be positioned without the hood (9), whether or not the car seat has a headrest (11). In this example, the storage mechanism may be positioned between a headrest (11) and the seat (10) itself.

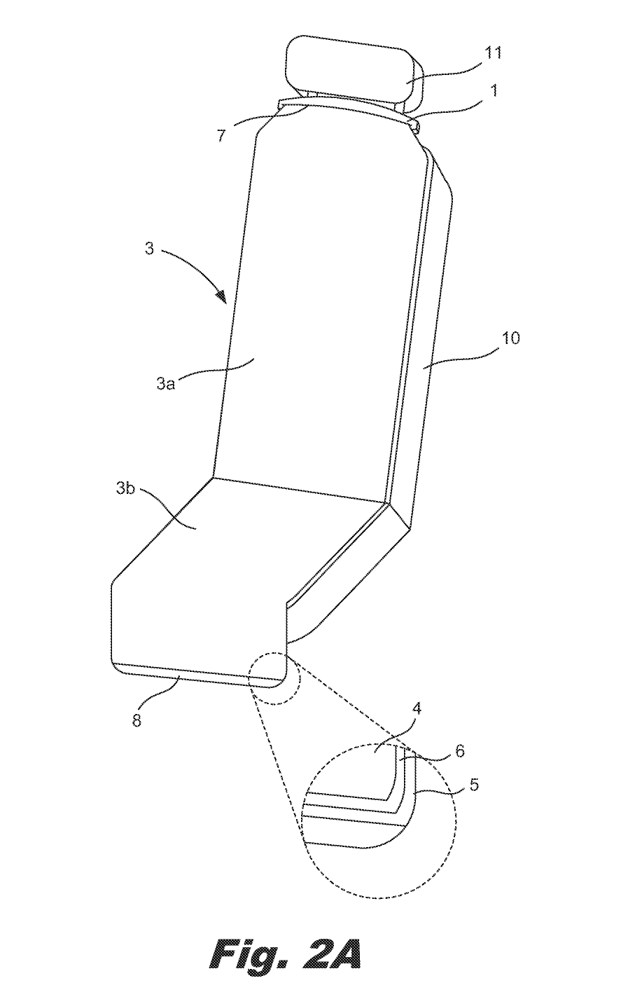

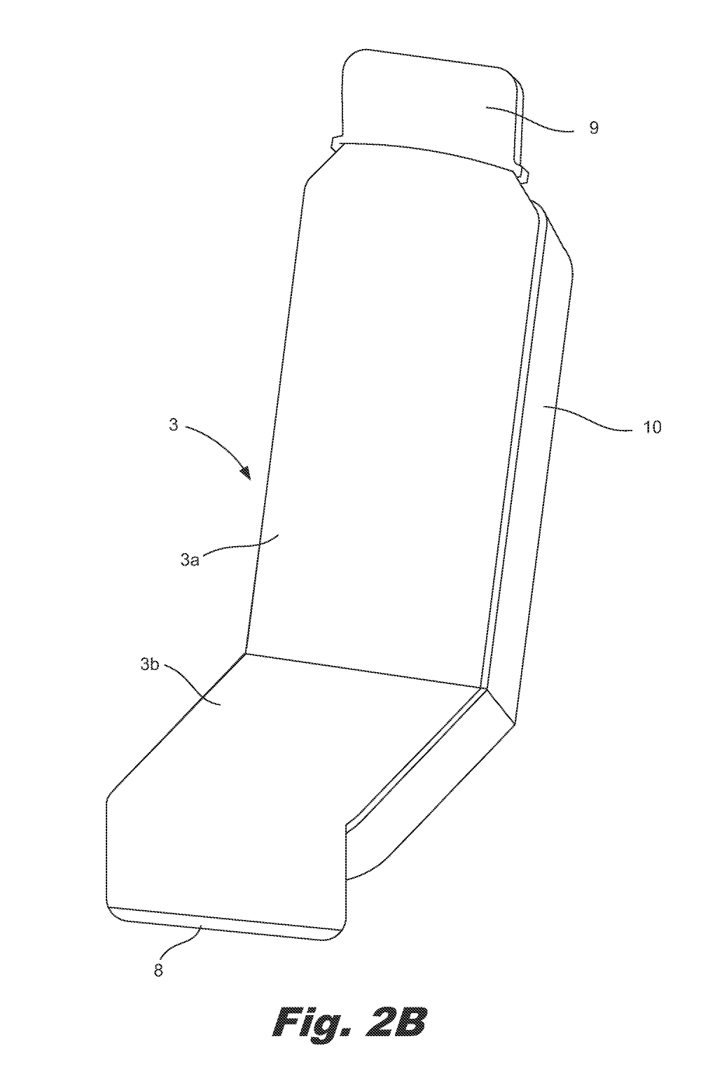

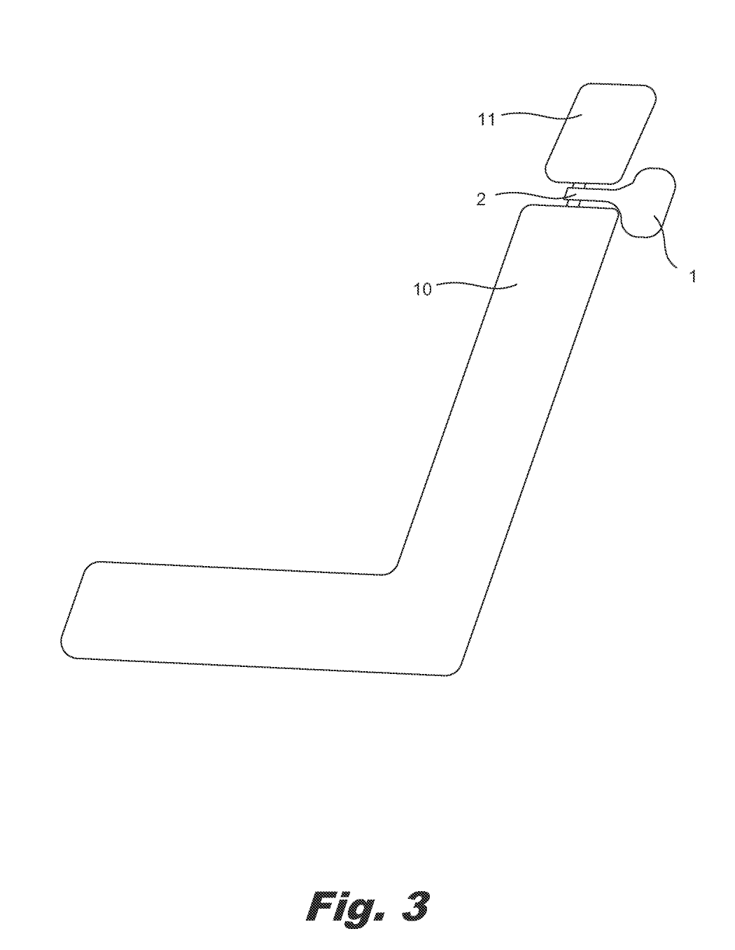

FIGS. 2A and 2B are perspective views of a removable antimicrobial seat cover (3), the removable seat cover (3) in a deployed mode according to one example of the principles described herein. As described above, the removable seat cover (3) may include a continuous antimicrobial seat cover (3) sized to cover a seat (10). The seat cover (3) may have a first surface (3b) to cover a seat portion of the seat (10) and a second surface (3a) to cover a seat back portion of the seat (10). As depicted in FIG. 2B, the seat cover (3) may include a hood (9) that may also be made from an antimicrobial material, the hood (9) enveloping a headrest (FIG. 1A, 11) of a seat (10). As depicted in FIG. 2A, the seat cover (3) may cover just the seat and seat back surfaces of the seat (10). In some examples, the hood (9) fabric may fall either relatively tightly or relatively loosely over the headrest (FIG. 2A, 11). In the event that the fit is relatively loose, a drawstring, hook and loop fastener, or the like, may be used to tighten the outer diameter of the hood (9) around the base of the headrest (11), so that the overall car seat cover (3) remains anchored to the seat (10).

In one example, the retention mechanism (FIG. 1, 2), the cords or strap, holds the storage mechanism onto the seat (10) back and is designed so that a quick installation of the seat cover (3), as well as a quick de-installation of the seat cover (3), to the seat (10) can be accomplished. In the case of the cords or strap, this design can include a strap or series of straps that use a retention mechanism that unites opposite ends of the straps so that the bag (1) is secured tightly about the seat (10). In one example, the straps can be tightened after the straps or cords are unified, so that the user can customize the tension to their liking.

The seat cover (3) and the hood (9) may be manufactured from various materials and may be composed of either a single layer of material or multiple layers of materials. For example, a layer with high liquid wicking and holding capabilities and a low coefficient of friction may form an upper layer (4) of the seat cover (3) where the user would make contact with the seat cover (3) when deployed; for example, when entering and exiting the vehicle as well as when traveling in the vehicle. The upper layer (4) may be formed of an antimicrobial layer that promotes the elimination of microbes. For example, the antimicrobial layer may include silver particles that oxidize in the presence of sweat to inhibit bacteria formation on the antimicrobial seat cover. More specifically, sweat, air, and silver particles in the antimicrobial material may generate positively charged silver ions that are attracted to negatively charged bacteria to prevent the formation of additional bacteria cells. While specific reference is made to silver being used in the antimicrobial seat cover, any material that may promote the elimination or reduction of microbes and bacteria, specifically those that cause odor, may be used in accordance with the principles described herein.

A layer having a low permeability coefficient as well as a high friction coefficient may be suitable for a lower layer (5) of the seat cover (3). The low permeability would prevent liquids from seeping into the seat (10) itself so as to maintain the cleanliness of the seat (10). Moreover, the high coefficient of friction would keep the seat cover (3) in place as the user moves about on the car seat (10). In some examples, middle layer(s) (6) may be placed between the upper layer (4) and the lower layer (5) for additional or similar purposes in order to optimize the overall design and comfort of the seat cover (3). As described above, the removable seat cover (3) may be designed to be readily removable and washable. Accordingly, the seat cover (3), belt portion, hood (9), storage mechanism (for example the bag (1) or other storage mechanism), or combinations thereof may be machine washable. In other examples, the material may maintain low levels of static charge.

In some examples, the seat cover (3) may include a securing mechanism (8) to secure the continuous antimicrobial seat cover (3) against at least a seat portion and a seat back portion of the seat (10). For example, the seat cover (3) may have weights on the edges or sides so that the seat cover (3) better remains in place, centered over the seat (10). Other examples of securing mechanisms (8) include straps, snaps, loops, buttons, zippers, hooks, clips, hook and loop fasteners and buckles, among other types of securing mechanisms (8).

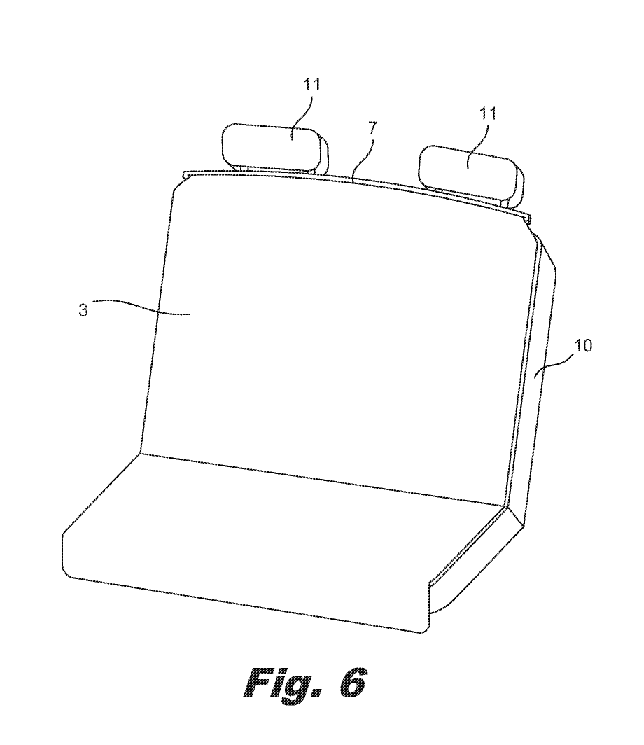

In one specific example, the securing mechanism (8) includes a boundary device that is positioned along a boundary of the first surface (3b) and the second surface (3a) of the seat cover (3). Put another way, the securing mechanism (8) includes a boundary device that is to be positioned between a seat portion and a back portion of the seat (10). The boundary device may affix the seat cover (3) in place such that it does not slide around when in use. In some examples, the boundary device may be a wedge that pressure fits between the seat portion and back portion of the car seat (10). More detail regarding the boundary device is given below in connection with FIG. 5.

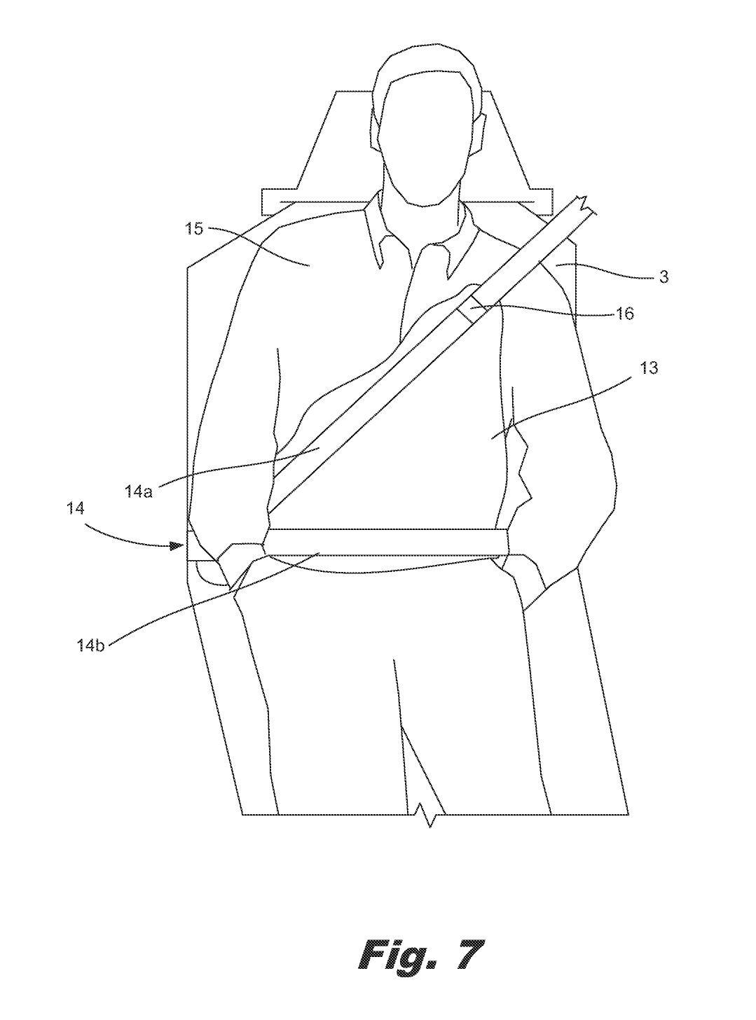

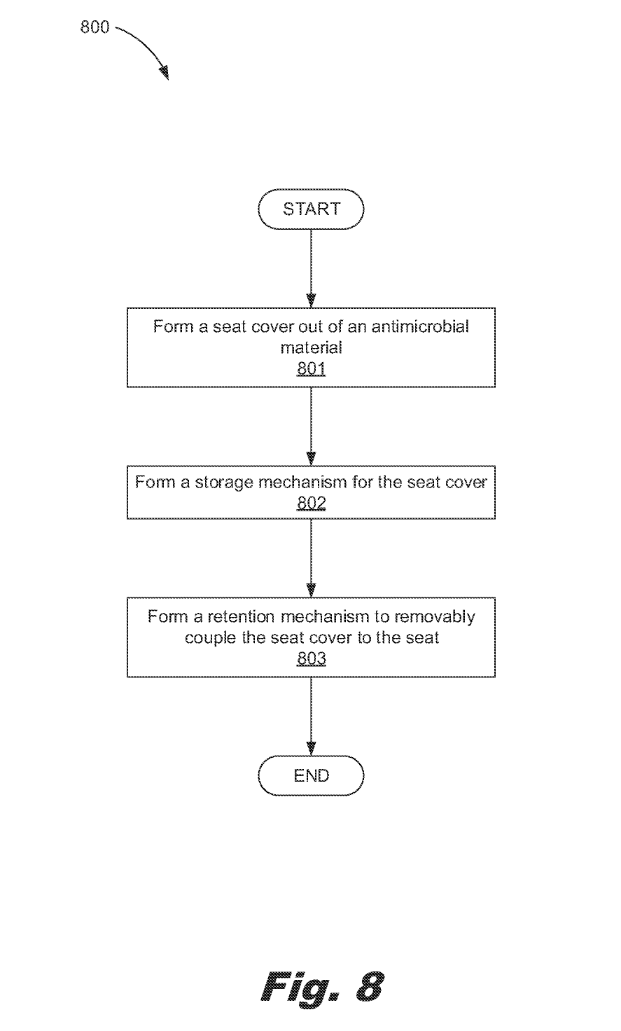

The seat cover (3) may include a belt portion that is positioned between the user and the safety belt. As described above, the seat belt of a seat (10) also comes into contact with a user's soiled clothing and may similarly deteriorate due to the exposure, create an unpleasant odor, and have detrimental effects when in contact with other, clean clothing. In some examples, the belt portion may be coupled to a side edge of the portion of the seat cover (3) that is disposed over the seat and seat back portions of the seat cover (3). The belt portion may be sized to be disposed between the user and a lap portion of the seat belt. The belt portion may be sized to be disposed between the user and a torso portion of the seat belt. When initially deployed the belt portion may be laid to the side of the seat portion of the seat cover (3). A user may then enter the vehicle and fold the belt portion across the portion of their body that will be in contact with the seat belt. The tension of the seat belt across the body may retain the belt portion as a barrier between the safety belt and the user. More detail regarding the belt portion of the seat cover (3) is given below in connection with FIG. 7.

In some examples, the seat cover (3), the storage mechanism, the hood (9), or combinations thereof are coupled to one another. For example, the various components may be stitched together via a stitching that is internal to the bag (1). In another example, the seat cover (3) and hood (9) may be removably coupled to the storage mechanism, for example via an additional zipper that is internal to the bag (1). While specific reference is made to stitching or a zipper, the present disclosure anticipates the use of any mechanism to secure the seat cover (3), hood (9), belt portion or combinations thereof together with the storage mechanism. Examples include hook and loop fasteners, snaps, buttons, loops, and knots among other mechanisms.

In one example, the device includes a mechanism whereby the outer, side portions of the seat cover (3) are held out to the sides of the storage mechanism so that the seat cover (3) has greater coverage, especially over the top portions of the seat (10). For example, the seat cover (3) may be wider than the bag (1) into which it is stored. Accordingly, the mechanism may enlarge and provide structural rigidity to the seat cover (3) such that it may be wider than the bag (1) and may be structurally sound while deployed. Such a mechanism can include spring hangars, small lateral posts, external strapping or the like.

While the figures present a seat cover (3) for a single seat (10), the devices and systems described herein may be applicable to a larger bench-style seat as well. More detail regarding a seat cover (3) for a bench-style seat is given below in connection with FIG. 6.

In one example, the seat cover (3) may include aesthetic components to create a visually pleasing seat cover (3). For example, a repeated pattern can be manufactured so that the pattern appears to be continuous between the seat cover (3), the bag (1), and the hood (9) with the entire product having a more refined, higher quality, and continuous look. Also, a visual creation can be manufactured using the contrasting shapes and textures of the seat cover (3), the bag (1), and the hood (9) as well as the relative momentary movement or location of these components. A specific example is given as follows. In this example, the bag (1) may have the marking and colorings of an animal's head, while the seat cover (3) might have the marking and color of an animal's tongue. In another example, the bag (1) might have the marking and color of a college's famous buildings and the seat cover (3) might have the marking and color of this college's logo or mascot.

As described above, in some examples, the seat cover (3) may have a hood (9) as depicted in FIG. 2B. In some examples the seat cover (3) may have covers for just the seat portion and the back portion of the seat (10) as depicted in FIG. 2A.

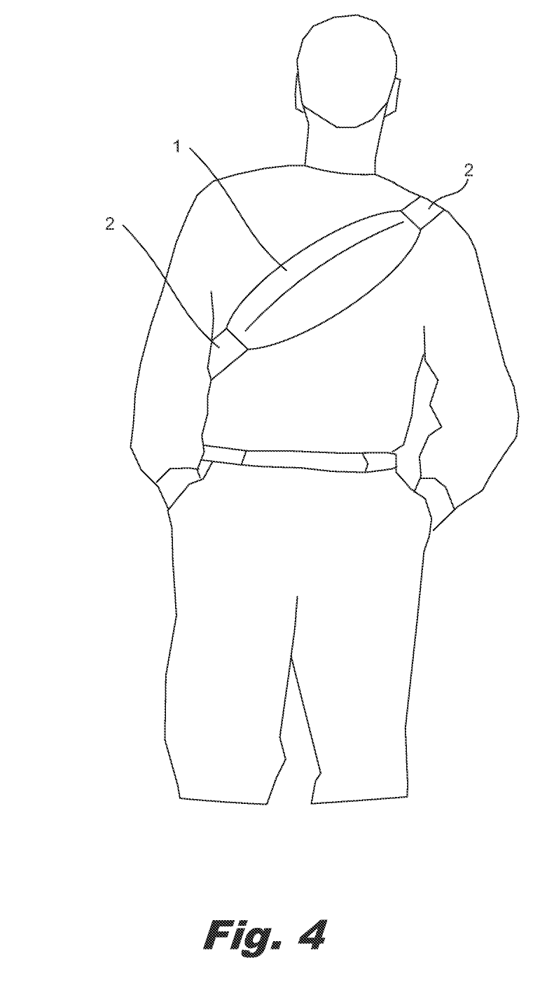

FIG. 3 illustrates the positioning of the removable antimicrobial seat cover (FIG. 2A, 3) in a storage mode according to one example of the principles described herein. More specifically, FIG. 3 illustrates how a storage mechanism and a retracted seat cover (FIG. 2A, 3) can be positioned from one side of the seat (10) to the other. For example, as described above the storage mechanism may include a handle. In one example, the handle may be designed such that if the user so desires, they can swing the storage mechanism and retained seat cover (FIG. 2A, 3) over or around the seat (10) or seat headrest (11). For example, in a deployed state or in a retracted state, as depicted in FIGS. 1A, 1B, 2A, and 2B, the storage mechanism may be on a front-facing surface of the car seat (10) such that the seat cover (FIG. 2A, 3) may cover the front surface of the seat (10). When not in use, the user may desire to move the seat cover (FIG. 2A, 3), for example, in order to gain additional space in the area of the headrest (11) while the seat cover (FIG. 2A, 3) is not in use, due to the geometry and design of that particular seat (FIG. 2A, 3). Accordingly, after use, the user may stuff, fold, roll, or otherwise dispose the seat cover (3) into the storage mechanism (i.e., bag (1)). A handle disposed on the storage mechanism may then allow the user to rotate the storage mechanism and accompanying retracted seat cover (FIG. 2A, 3) to a rear-facing portion of the seat (10) as depicted in FIG. 3. Additionally, the user may desire to deploy the seat cover (FIG. 2A, 3) on a rear surface of the seat (10) for numerous reasons, or simply to store the seat cover (FIG. 2A, 3) out of the way for an extended period of time.

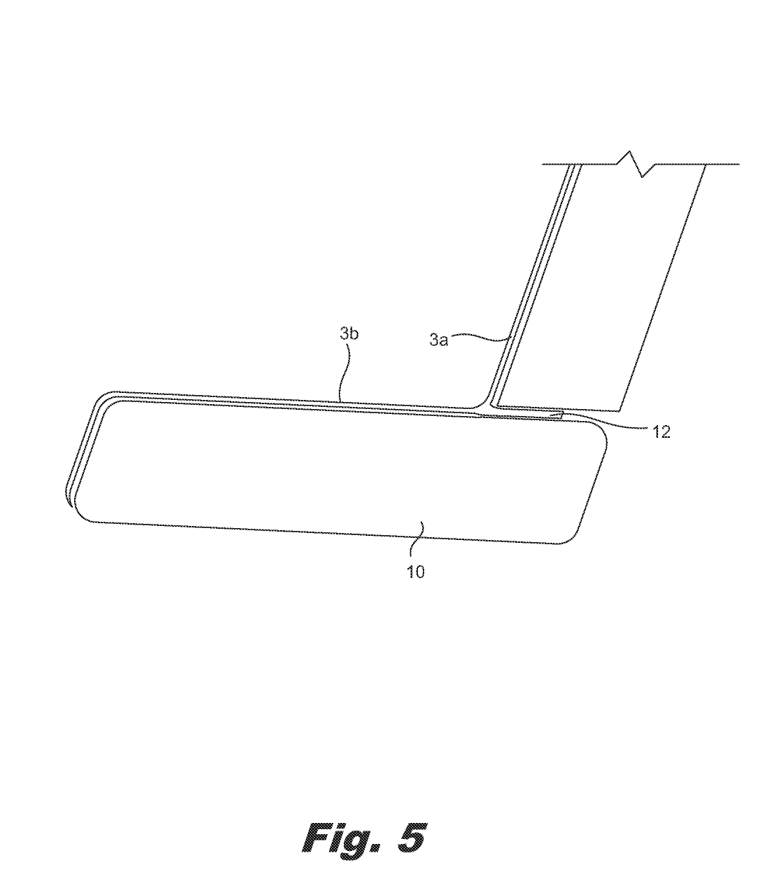

FIG. 4 is a back view of the removable antimicrobial seat cover (FIG. 2A, 3) in a storage mode according to another example of the principles described herein. More specifically, FIG. 4 is a view of the seat cover (FIG. 2A, 3), as it would appear while being transported to/from a vehicle. As described above, the seat cover (FIG. 2A, 3) may be designed so as to be reusable and machine washable. Accordingly, the retention mechanism (2) may allow for the seat cover (FIG. 2A, 3) to be removed from the car seat (FIG. 1A, 10) and transported, for example, to a laundry machine. In other words, the removable device allows the user to retract the seat cover (FIG. 2A, 3) into the bag (1) in order to conveniently carry the seat cover (FIG. 2A, 3) to, for example, a laundry room, where the entire seat cover system can be laundered. As described in connection with FIG. 3, the retention mechanism (2) may include a strap that is unified around the headrest (FIG. 1A, 11) to secure the seat cover (FIG. 2A, 3) to the seat (FIG. 1A, 10). The same strap when unified, serves as a convenient and practical way of carrying the seat cover (FIG. 2A, 3) at a time when the user may be carrying other objects, such as grocery bags, purses, keys, laptops, or briefcases. If another retention mechanism (2) is used, a separate handle or strap may be included such that the seat cover (FIG. 2A, 3) in the bag (1) may be easily transported. In one example, the seat cover system is put into a washing machine in a deployed mode.

FIG. 5 is a side view of the removable antimicrobial seat cover (3) in a deployed mode according to another example of the principles described herein. More specifically, FIG. 5 depicts the removable seat cover (3) with a boundary device (12) as described above. More specifically, the removable seat cover (3) may have rigid tabs, which are connected to the seat cover fabric and that wedge into a slot between the seat portion and the back portion of the seat (10). The boundary device (12) may produce tension on the seat cover (3) providing for better alignment of the seat cover (3) with the seat (10) and for better retaining the seat cover (3) over the seat (10). Including a boundary device (12) may be beneficial when the angle of the seat (10) entry or exit may be acute enough to cause the sliding of the seat cover (3) fabric over the seat (10) itself, resulting in less overall coverage, as well as potential discomfort for the user. While FIG. 5 specifically illustrates wedges, other types of boundary devices (12) may be used in conformance with the device described herein.

FIG. 6 is a perspective view of the removable antimicrobial seat cover (3) for protecting a bench seat (10) according to one example of the principles described herein. As described above, the seat cover (3) may be applied to a single seat or a bench multi-user seat. In this example, the concepts, processes, and components described herein may be applied to a larger device that covers more seat space. In this example, the seat cover (3) may include multiple storage mechanisms to retain portions of the bench-size seat cover (3). Similarly, there may be additional retention mechanisms (FIG. 1A, 2), such as more straps to retain the seat cover (3) in a retracted mode when not in use. Still further, the bench-size seat cover may include additional securing mechanisms to retain the seat cover material adjacent to the seat.

FIG. 7 is a perspective view of the removable antimicrobial seat cover (3) having a belt portion (13) according to one example of the principles described herein. More specifically, FIG. 7 shows an antimicrobial seat cover (3) that includes a piece of fabric to protect the seat belt (14) from becoming wet/soiled. The belt portion (13) of the seat cover (3) may be attached to the main portion of the car seat cover (3). As described above, in some examples, the belt portion (13) wraps around the front of the driver or car occupant (15) and is located between the seat belt (14) and the driver or occupant (15). In some examples, a clip, or other retaining device (16), that may be integrally formed with the belt portion (13), holds the belt portion (13) into place on the seat belt (14). While specific reference is made to clips, other retaining features may be used such as look and loop fasteners, magnets, clips, buckles. In one example, the pressure of the seat belt (14) against the user's (15) body may retain the belt portion (13) in place between the seat belt (14) and the user (15).

While specific reference is made to the belt portion (13) being attached to the seat cover (3), in some examples, the seat belt portion (13) may be completely detached from the car seat cover (3). Moreover, while FIG. 7 depicts a continuous belt portion (13), the belt portion (13) may include multiple pieces. For example, one piece can fit around a torso belt (14a) and a second piece can fit around the lap belt (14b). Various components may secure these pieces (13) including hook and loop fasteners, snaps, buttons, loops, knots, zippers and the like. In yet another example, the seat belt portion (13) may be removably coupled to the seat belt (14). In this example, the seat belt portion (13) may become a semi-permanent fixture to the seat belt (14) or it can be quickly deployable/retractable, as with the car seat cover (3).

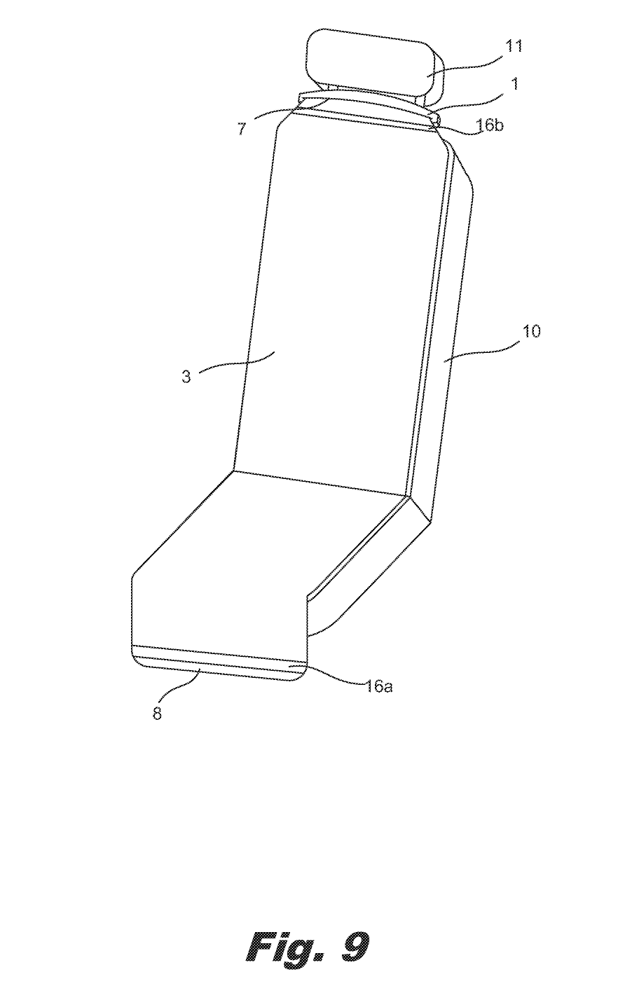

FIG. 8 is a flow diagram of a method (800) of making a removable antimicrobial seat cover (FIG. 2A, 3) according to one example of the principles described herein. The method (800) may include forming (block 801) a seat cover (FIG. 2A, 3) out of an antimicrobial material. For example, an antimicrobial material that promotes the elimination of microbes and bacteria may be used to form the seat cover (FIG. 2A, 3). Forming (block 801) the seat cover (FIG. 2A, 3) out of an antimicrobial material may include forming a belt portion (FIG. 7, 13) of the seat cover (FIG. 2A, 3) and a hood portion (FIG. 1B, 9) of the seat cover (FIG. 2A, 3) out of the antimicrobial material, similarly with the advantage of promoting the elimination of microbes and bacteria, specifically microbes and bacteria that result in unpleasant odor. Forming (block 801) the seat cover (FIG. 2A, 3) may include positioning different layers of material having different properties against one another. For example, the seat cover (FIG. 2A, 3), belt portion (FIG. 7, 13), hood (FIG. 1B, 9), or combinations thereof may include a lower layer (FIG. 2A, 5) that is designed to keep the seat cover (FIG. 2A, 3) in position on the seat (FIG. 1A, 10) when deployed. Moreover, the bottom layer (FIG. 2A, 5) may be impermeable such that bacteria and microbes are not transferred from another layer to the car seat (FIG. 2A, 3). The seat cover (FIG. 2A, 3), belt portion (FIG. 7, 13), hood (FIG. 1B, 9), or combinations thereof may also include an upper layer (FIG. 2A, 4) that is designed to wick moisture away from the seat. The upper layer (FIG. 2A, 4) may also have a low coefficient of friction to allow a user to easily enter and exit the vehicle. Additional layers (FIG. 2A, 6) may be present to achieve different functional results.

Forming (block 801) the seat cover (FIG. 2A, 3) may include joining a securing mechanism (FIG. 2A, 8) to the seat cover (FIG. 2A, 3). As described above, the securing mechanism (FIG. 2A, 8) may more securely position the seat cover (FIG. 2A, 3) adjacent the seat (FIG. 1A, 10). The securing mechanism (FIG. 2A, 8) may include straps, buckles, clips, and magnets among other securing mechanisms (FIG. 2A, 8) that are joined to the edges of the seat cover (FIG. 2A, 3) that allow for temporary attachment to the seat (FIG. 1A, 10). In another example, the securing mechanism (FIG. 2A, 8) may include a boundary device (FIG. 5, 12) between a first surface ((FIG. 2A, 3b) aligned with the seat portion of the seat (FIG. 1A, 10)) and a second surface ((FIG. 2A, 3a) aligned with the seat back portion of the seat (FIG. 1A, 10)). The boundary device (FIG. 5, 12) may be designed to be inserted between the seat and seat back surfaces to increase the tension on the seat cover (FIG. 2A, 3) so as to maintain the seat cover (FIG. 2A, 3) in place over the car seat (FIG. 1A, 10).

The method (800) includes forming (block 802) a storage mechanism for the seat cover (FIG. 2A, 3). As described above the storage mechanism may be any device which maintains the seat cover (FIG. 2A, 3) away from the car seat (FIG. 1A, 10) when the seat cover (FIG. 2A, 3) is not in use. Examples of storage mechanisms include pouches (FIG. 1A, 1), straps, buckles, hook and loop fasteners, snaps, and magnets, among other storage mechanisms. The storage mechanism may be formed such that when the seat cover (FIG. 2A, 3) is in a retracted state, the storage mechanism does not pose any danger or discomfort to the user and is retained to the car seat (FIG. 1A, 10) when the seat cover (FIG. 2A, 3) is not in use.

Forming (block 802) the storage mechanism may include forming a handle on the storage mechanism. As described above, the handle may be used to move the retracted seat cover (FIG. 2A, 3) around the seat (FIG. 1A, 10), during storage for example. Similarly, the handle may be used to transport the cover, for example to a laundry machine for laundering. Forming the storage mechanism may include removably coupling the seat cover (FIG. 2A, 3) to the storage mechanism. For example, the cover may be designed such that the seat cover (FIG. 2A, 3), belt portion (FIG. 7, 13), hood (FIG. 1B, 9) or combinations thereof may be removed for laundering. In some examples, the laundering may not be intended for the storage mechanism. For example, the storage mechanism may be retained on the seat (FIG. 1A, 10) while the seat cover (FIG. 2A, 3), belt portion (FIG. 7, 13), and hood (FIG. 1B, 9) are removed from laundering. Examples of such removable couplers include zippers, snaps, magnets, hook and loop fasteners, and other removable couplers.

The method includes forming (block 803) a retention mechanism to removably couple the seat cover (FIG. 2A, 3) to the seat (FIG. 1A, 10). Examples of such retention mechanisms include snaps, straps, hook and loop fasteners, buckles, knots, and magnets, among other retention devices.

FIG. 9 is a perspective view of the removable antimicrobial seat cover (3), the removable seat cover in a deployed mode according to another example of the principles described herein.

As described above, the continuous antimicrobial seat cover (3) may be folded, stuffed, rolled, or otherwise disposed inside the storage mechanism i.e., the bag (1). Storing the continuous antimicrobial seat cover (3) inside a storage mechanism such as the bag (1) or pouch may include folding the seat cover (3) such that a surface of the material that has come into contact with the soiled clothing is not in contact with other surfaces of the seat cover (3) which are clean. In this fashion any contamination from sweat, or other solids and liquids may be contained to a single surface of the seat cover (3) without coming into contact with, and contaminating, other surfaces. In this fashion, the continuous antimicrobial seat cover (3) may enable non-contamination of surfaces of the seat cover (3) that come into contact with the car seat (10).

To this end, the seat cover (3) may include a folding mechanism to assist in retraction of the seat cover (3). The folding mechanism may include two parts, a lower part (16a) disposed near the bottom of the seat cover (3) and an upper part (16b) disposed near the top of the seat cover (3) proximate to the bag (1). Examples of attachment mechanisms (16) include hook-and-loop fasteners, magnets, clips, or other attachment mechanisms (16).

When retracting the seat cover (3), the lower part (16a) of the attachment mechanism is mated with the upper part (16b) of the attachment mechanism. Accordingly, when the user wishes to retract the seat cover (3), the user simply folds the seat cover (3) in half. Accordingly, the dirty side of the seat cover (3) is prevented from contacting the clean side of the seat cover (3) thus preventing the spreading of bacteria. Once folded, the user may continue to roll, stuff or otherwise locate the seat cover (3) within the bag (1).

The removable antimicrobial seat cover (FIG. 2A, 3) may have a number of advantages, including: (1) quick and easy deployment of a temporary barrier between soiled clothing and a seat surface; (2) quick and easy deployment of a temporary barrier between soiled clothing and a safety belt; (3) prevention and elimination of odor-causing bacteria via use of an antimicrobial material for the seat cover; (4) easy, out-of-sight storage of the seat cover when not in use; and (5) simple washing of the protective seat device

The preceding description has been presented to illustrate and describe various examples of the principles described. This description is not intended to be exhaustive or to limit these principles to any precise form disclosed. Many modifications and variations are possible in light of the above teaching.

What is claimed is:

1. A removable antimicrobial seat cover, the cover comprising:
a continuous antimicrobial seat cover, the cover having a first surface to cover a seat portion of the seat and a second surface to cover a seat back portion of the seat;
a storage mechanism to store the continuous antimicrobial seat cover away from the seat when not in use, in which the storage mechanism is coupled to the seat when the continuous antimicrobial seat cover is not in use; and
a retention mechanism to removably couple the storage mechanism to the seat.

2. The cover of claim 1, in which the continuous antimicrobial seat cover comprises a belt portion to be positioned across a user to provide a barrier between a safety belt of the seat and the user.

3. The cover of claim 2, in which the belt portion is coupled to a side edge of the continuous antimicrobial seat cover.

4. The cover of claim 1, in which the continuous antimicrobial seat cover is removably coupled to the storage mechanism.

5. The cover of claim 1, in which the continuous antimicrobial seat cover is sized to cover a bench seat.

6. The cover of claim 1, further comprising a securing mechanism to secure the continuous antimicrobial seat cover against at least the seat portion and the seat back portion of the seat.

7. The cover of claim 6, in which the securing mechanism includes a boundary device positioned along a boundary of the first surface and the second surface of the seat cover, the boundary device to be positioned between the seat portion and the seat back portion of the seat.

8. The cover of claim 1, in which the continuous antimicrobial seat cover comprises a hood portion to cover a headrest of the seat.

9. The cover of claim 1, in which the retention mechanism removably couples the storage mechanism to a side surface of the seat.

10. The cover of claim 1, in which the retention mechanism removably couples the storage mechanism near a headrest of the seat.

11. The cover of claim 1, further comprising a number of aesthetic components to create a visually pleasing seat cover.

12. The cover of claim 1, in which the seat cover is disposed within the storage mechanism such that a surface of the seat cover that is in contact with the seat is not in contact with a surface of the seat cover that has been in contaminated.

13. A removable seat protection system, the system comprising:
an antimicrobial seat cover sized to cover a seat, the seat cover having a first surface to cover a seat portion of the seat and a second surface to cover a seat back portion of the seat;
an antimicrobial belt cover disposed along an edge of the antimicrobial seat cover, in which the belt cover is sized to provide a barrier between a safety belt and a user;
an antimicrobial hood sized to cover a headrest portion of the seat;
a storage mechanism to store the seat cover, belt cover, and hood away from the seat when not in use, in which the storage mechanism is coupled to the seat when the continuous antimicrobial seat cover is not in use; and
a retention mechanism to removably couple the storage mechanism to the seat.

14. The system of claim 13, in which the antimicrobial belt cover is disposed between a user and a lap portion of a safety belt, a torso portion of the safety belt, or combinations thereof.

15. The system of claim 13, in which the antimicrobial seat cover, antimicrobial belt cover, antimicrobial hood, or combinations thereof are formed of an antibacterial material.

16. The system of claim 13, in which the system is machine washable.

17. The system of claim 13, in which the storage mechanism is an airtight storage component.

18. The system of claim 13, in which the seat cover, the belt cover, and the hood are formed from moisture-wicking materials.

19. A method for making a removable antimicrobial seat cover, the method comprising:
forming a seat cover out of an antimicrobial material, the seat cover being elongated and sized to fit over at least a seat portion of an automobile seat and a seat back portion of an automobile seat;
forming a storage mechanism, in which the seat cover is disposed inside the storage mechanism when not in use; and
forming a retention mechanism to removably couple the seat cover to the seat.

20. The method of claim 19, further comprising forming a handle on the storage mechanism for transport of the removable antimicrobial seat cover.
